(19) United States
(12) Patent Application Publication
(10) Pub. No.: US 2009/0004323 A1
(43) Pub. Date: Jan. 1, 2009

(54) Needle Valve Nozzle Assembly

(75) Inventor: Josef Krummenacher, Muri (CH)

Correspondence Address: THE WEBB LAW FIRM, P.C., 700 KOPPERS BUILDING, 436 SEVENTH AVENUE, PITTSBURGH, PA, 15219, US

(73) Assignee: AWM MOLD TECH AG, Muri (CH)

(21) Appl. No.: 12/147,063

(22) Filed: Jun. 26, 2008

(30) Foreign Application Priority Data
Jun. 27, 2007 (CH) 1037/07

(51) Int. Cl. B29C 45/00

(52) U.S. Cl. 425/568

(57) ABSTRACT

The present invention relates to a manifold unit for supplying casting material in an injection moulding system for processing thermoplastic polymers via a hot runner system with at least one needle valve nozzle which can be sealed by a shut-off needle. In this case, the shut-off needle can be moved by a hydraulic or pneumatic drive system. The needle valve nozzle has a first longitudinal axis and the drive system, which has a piston, has a second longitudinal axis, the first longitudinal axis being arranged parallel to and laterally offset from the second longitudinal axis.

### TECHNICAL FIELD

The present invention relates to a device for supplying casting materials in an injection moulding process, in particular for a hot runner system with a needle valve, which system has a particularly low installation height.

### PRIOR ART

Needle shut-off moulds have the advantage of allowing a clean sprue for the processing of plastics materials. An injection mould is a mould consisting of a plurality of modules for producing large quantities of plastics material parts. A plurality of plastics material parts can be produced simultaneously at a plurality of parting planes in a mould. The plastics material is injected at high pressure into the cavities of the mould through the supply channels by means of a cylinder. Melted plastics material is kept at temperature in the hot runner. Hot runner systems can be divided into open or closed systems, the relevant factor being whether the feed point was actuated by a sprue needle pneumatically, mechanically, electrically or hydraulically. The hot runner ends in the hot runner nozzle which is the point of transition between the heated and unheated zone in the injection mould. Hot runner systems have what is known as a needle shut-off mechanism in which the injection nozzle is closed immediately after the injecting and subsequent after-pressing by a shut-off needle.

Various needle valve injection nozzles are known in the art. For example, DE 295 04 162 discloses an injection nozzle, the shut-off needle of which is exposed to as little heat as possible. EP 0 558 932 A1 discloses a multiple needle valve nozzle, two nozzles having a common piston drive. DE 32 49 486 discloses a needle valve nozzle with two drive pistons. US 2003/0180409 A1 discloses systems with various drives, each arranged after the nozzle, for actuating the shut-off needle.

### ACCOUNT OF THE INVENTION

The present invention is accordingly based partly on the object of providing a manifold unit having a lower overall height.

The core of the invention is to provide a manifold unit for supplying sprue material in an injection moulding system for processing thermoplastic materials via a hot runner system, which manifold unit has at least one needle valve nozzle which can be sealed by a shut-off needle. In this case, the shut-off needle can be moved by a hydraulic, mechanical, electric or pneumatic drive system. The needle valve nozzle has a first longitudinal axis and the drive system, which has at least one piston, has a second longitudinal axis, the first longitudinal axis being arranged parallel to and laterally offset from the second longitudinal axis.

In other words, the manifold unit according to the invention allows the drive system of a needle valve nozzle not to be arranged coaxially with the longitudinal axis and after the nozzle; instead, the drive system is arranged parallel and offset next to the needle valve nozzle, for example respectively next to a hot runner manifold block of the manifold unit. The longitudinal axis of the drive system is thus not aligned with the longitudinal axis of the needle valve nozzles.

In conventional hot runner systems, the drive system, i.e. the drive piston or the cylinder or the guide pillar, is arranged coaxially with the nozzle. The coaxial arrangement of, for example, two nozzles pointing in two opposite directions then causes a further two drive systems, i.e. two pistons or cylinders, also to be arranged coaxially between the two nozzles. The construction resulting therefrom is very wide or has a large overall depth. The positioning in accordance with the invention of the drive next to the nozzle allows a coaxial arrangement of two nozzles with a minimum installation depth.

A lateral arrangement of the drive system relative to the needle valve nozzle has the further advantage that the drive can be placed in the cold region (i.e. out of the region where hot material flows in the hot runner), thus allowing, for example, the use of a hydraulic drive. One drawback of a drive system arranged in the warm region is that its large amount of heat can weaken the system. The use of hydraulics allows the drive system to have a smaller diameter, as the medium is substantially non-compressible. In addition, the pressures of the needle movement can be set with greater precision. The smaller diameter of the piston allows smaller distances between the nozzles or distances between the cavities to be adhered to.

According to a first embodiment of the invention, the shut-off needle is driven by the piston via a lever arm, the shut-off needle being arranged substantially perpendicularly to the lever arm. The longitudinal axis of the piston is in this case arranged substantially perpendicularly to the lever arm, so the shut-off needle, the lever arm and the piston describe a substantially U-shaped arrangement.

According to a further preferred embodiment of the invention, the lever arm is capable of surrounding with its free end at least one needle head, which is arranged at an end of the shut-off needle that is remote from a material outlet, and preferably in addition a spacer sleeve partly encasing the shut-off needle. This surrounding couples the pneumatically or hydraulically triggered raising and lowering of the piston to the movement of the shut-off needle and thus also to the retraction and extension thereof, and the use of the spacer sleeve allows simple regulation of stop positions.

According to a further embodiment of the invention, the manifold unit has at least two needle valve nozzles, the longitudinal axes of which are preferably arranged coaxially, each needle valve nozzle having a nozzle head with an opening, which can be sealed by the shut-off needle, for the outflow of the casting material. The nozzle heads of the two needle valve nozzles preferably point away from each other in opposite directions (back-to-back arrangement). Preferably, the shut-off needles of each two needle valve nozzles, which are arranged coaxially with each other, can be moved by the drive system, the first drive system having a first piston and the second drive system having a second piston, and the two drive systems have at least one common guide element, the pistons preferably being arranged coaxially. The guide element which is common to the two shut-off needles may, for example, be a guide cylinder which is preferably arranged in an axial fastening hole in the first piston and in an axial hole in the second piston. In other words, two coaxially arranged pistons can advantageously have a common guide cylinder, preferably a guide cylinder arranged in an axial hole in the piston or pistons. The movement of the pistons is transmitted to the shut-off needles via lever arms.

In this case, the drive system advantageously also has a first cavity, in which the first piston having a first head region runs or is movably mounted, and optionally a second cavity in which the second piston, which has a second head region pointing in the opposite direction to the first head region, runs or is movably mounted. The head region can be formed integrally with the piston and/or configured in one piece with the lever arm.

Advantageously, the first piston is screwed to the guide cylinder by means of a fastening screw which is guided in the first axial fastening hole in the first piston, the guide cylinder being displaceably movable in the second axial hole in the second piston, the second axial hole preferably having a ball cage.

Preferably, the first and the second piston are configured to be capable of actuating via two lever arms, which are arranged parallel to each other, at least two shut-off needles which are movably mounted in needle valve nozzles which are preferably arranged coaxially with one another and oriented in opposite directions. In this case, the two pistons can jointly actuate at least two shut-off needles via two lever arms. It is however also conceivable for each piston to be coupled to two shut-off needles via two lever arms which are arranged parallel to each other. In particular, it is advantageous if both lever arms in the drive system are responsible for the two shut-off needles. In this case, the two lever arms preferably have the same cross section. A movement of the pair of lever arms induced by the piston or pistons presses the two lever arms apart in the direction of the respective nozzle head, thus forming a gap or a double stroke between the two lever arms. Each lever arm presses in turn, through its movement, the two shut-off needles coaxially apart, i.e. the needle heads, which are arranged at the base of the shut-off needles, move apart from each other as the needles are extracted. The two pistons, which are arranged coaxially with each other, preferably run in opposite directions.

According to a further preferred embodiment, the lever arm is capable of actuating at least one, preferably two or more shut-off needles which are mounted in needle valve nozzles which are arranged parallel to one another and oriented in the same direction.

According to a further preferred embodiment of the invention, the manifold unit has at least two needle valve nozzles, the longitudinal axes of which are arranged parallel to and laterally offset from one another, the nozzle heads of the two needle valve nozzles pointing in the same direction. In this case, each needle valve nozzle has a nozzle head with an opening, which can be sealed by the shut-off needle, for the outflow of the casting material and the shut-off needles of the needle valve nozzles can be moved by a common drive system.

The lever arm can be configured in a fork-like manner with at least two fingers, each finger preferably having at its free end a recess which is capable of surrounding the needle head and optionally the spacer sleeve of the shut-off needle.

Furthermore, it is preferable for two coaxially arranged pistons together to drive at least four shut-off needles. In this case, half of the four needle valve nozzles, in each of which a shut-off needle is received, are advantageously arranged on a first side of the hot runner manifold and the other half of the needle valve nozzles at a second side of the hot runner manifold opposing the first side. Preferably, the needle valve nozzles are arranged in pairs on the manifold unit.

According to a further preferred embodiment according to the invention, each lever arm has an even number of fingers, preferably at least two or four fingers, each finger being capable of actuating at least one shut-off needle. As an alternative to a parallel arrangement, the fingers can also be arranged on the lever arm around the piston in a circular or star-shaped manner.

According to a further preferred embodiment, the lever arm engages with at least one opening in the hot runner manifold block in which the at least one needle valve nozzle is arranged. According to the invention, it is preferable for the at least one drive system to be arranged outside the hot runner manifold block or the hot region in which the hot runner extends.

The drive system may also be capable of operating a plurality of needle valve nozzles arranged parallel to and laterally offset from one another, the needle valve nozzles being coupled to the piston either via a common finger or bar or via various fingers, which are arranged parallel to one another, of a lever arm. If a plurality of needle valve nozzles are arranged in series along a bar, it can be advantageous for the purpose of stabilization if a second drive system or a second piston is arranged at the other end of the bar.

As an alternative to the foregoing embodiments in which a guide cylinder is arranged in the manifold unit, it is also possible to provide a manifold unit where only the guide is arranged in the hot runner manifold block and the actual hydraulic mechanism or piston chamber can be locked if required, or for a hydraulic piston to be attachable if required to actuate the needle.

In the case of a precentred cylindrical needle valve, during the shut-off movement, the needle is first precentred and brought to the sprue hole by means of a cylindrical guide. US 2004/0256767 A1 mentions the possibility of a hydraulic or pneumatic drive for a valve and describes the problem that very precise adaptation of the shut-off valve is necessary, as the components thermally expand on heating. The final adaptation of the position of the needle is however highly complex and time-consuming. A further advantage of the present invention over the prior art is thus, if the above mentioned spacer sleeve is used, that the shut-off needle no longer has to be adapted or centred with such precision; instead, its position can deviate by the extent to which it expands on heating.

In addition, the present invention can prevent the leverage effect, as any force-conditioned angular misalignment of the components can be compensated for by a common guide. The path of the needle can be fixed and the piston and the shut-off needle do not move coaxially with each other and have their own front and rear stop.

Multi-level systems have the drawback that the plastics material is multiply deflected and that the residence time of the plastics material in the runners or holes is longer than in normal systems. In the present invention, the plastics material is introduced into the hot runner substantially in the centre of the manifold unit or in the hot runner manifold block and is then distributed to the various holes over paths of substantially the same length and with as few deflections as possible. This also reduces the residence time of the material in the system.

Further preferred embodiments of the invention are described in the dependent claims.

### BRIEF DESCRIPTION OF THE FIGURES

The invention will be described hereinafter in greater detail based on exemplary embodiments and with reference to the drawings, in which:

FIG. 1 is a partial section through a manifold unit, FIG. 1a showing two needle valve nozzles with retracted shut-off needles and FIG. 1b two needle valve nozzles with extended shut-off needles; and

FIG. 2 is a perspective view of a drive system with four needle valve nozzles, FIG. 2a showing four needle valve nozzles with extended shut-off needles and FIG. 2b four needle valve nozzles with retracted shut-off needles; and

FIG. 3 is a perspective view of the manifold unit according to the invention with the arrangement of 2×16 needle valve nozzles.

### WAYS OF CARRYING OUT THE INVENTION

Exemplary embodiments will be discussed hereinafter to document the proposed manifold unit. This discussion of the exemplary embodiments is intended by way of support and should not be used restrictively to interpret the scope of protection such as is defined in the likewise appended claims.

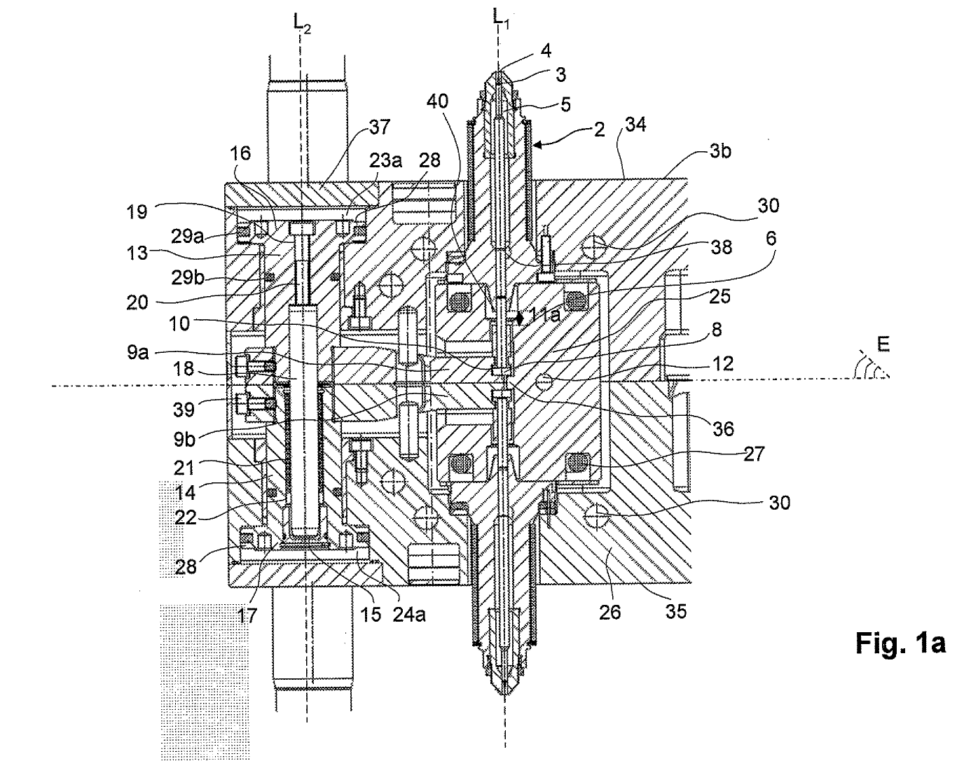

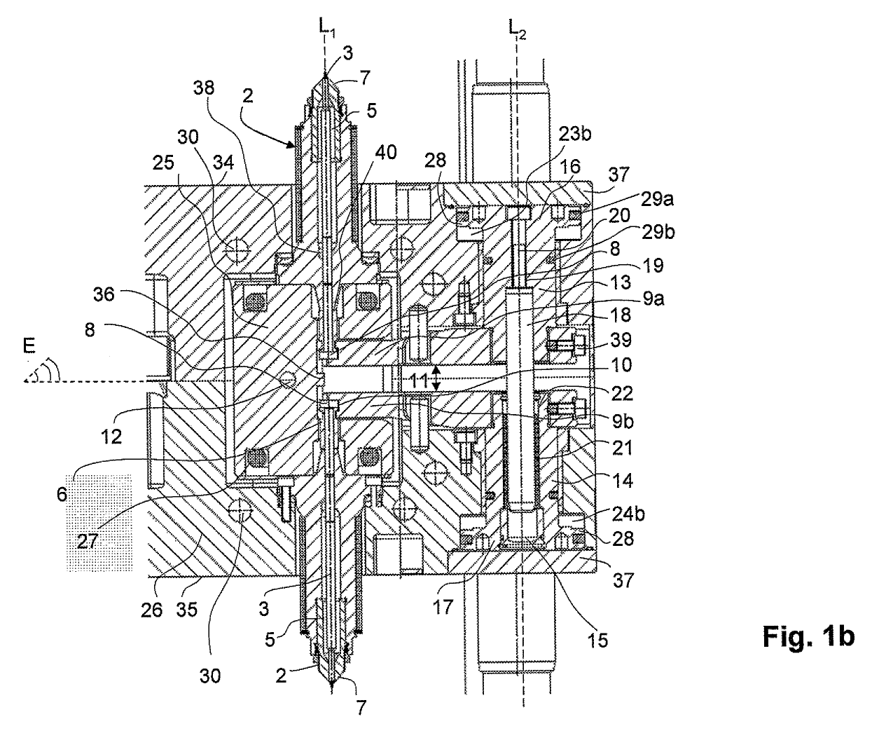

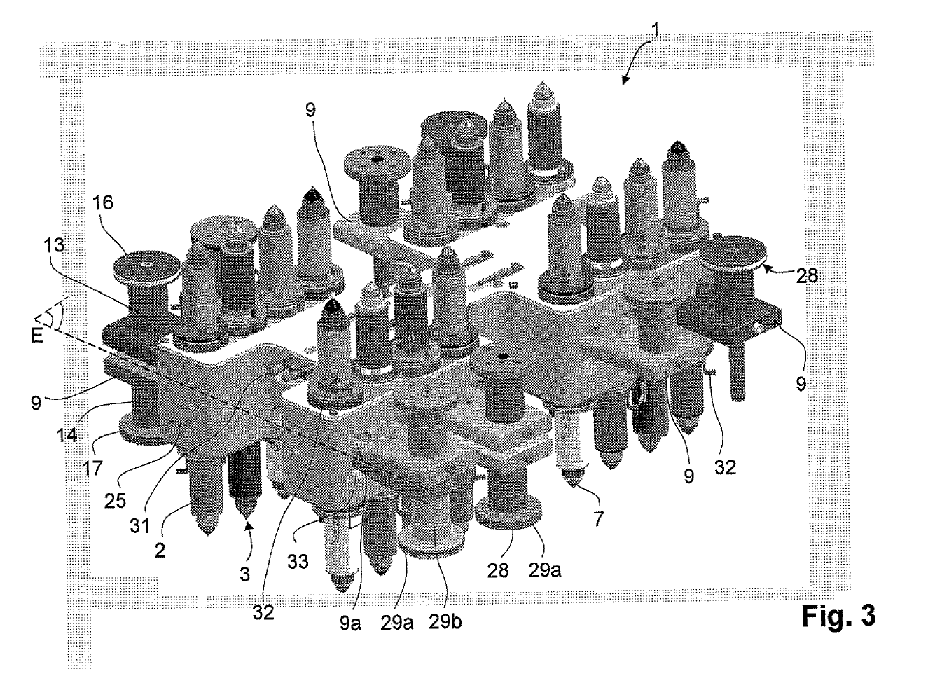

FIGS. 1a and 1b show part of a preferred exemplary embodiment of a manifold unit I according to the invention. The manifold unit 1 has a hot runner manifold block 25 which is heated via a block heating line 31 (cf. FIG. 3) and mould plates 26 cooled via cooling channels 30. Needle valve nozzles 2, which are known per se and the nozzle heads 7 of which point in opposite directions along their common longitudinal axis L1, are arranged coaxially on both sides 34, 35 of the manifold unit 1. A drive system is provided laterally offset from the two needle valve nozzles 2 shown and coupled to the needle valve nozzles 2 via two lever arms 9 (shown on the left-hand side in FIG. 1a and on the right-hand side in FIG. 1b). However, according to another embodiment, it is also possible for needle valve nozzles 2 to be arranged merely on a first side 34 of the manifold unit 1.

The needle valve nozzle 2 has in a central hole a shut-off needle 3 which is mounted so as to be displaceably movable and also, coaxially therewith, a material channel 5 through which the material is guided from the inlet opening 33 to the needle guide or opening 4, arranged in the nozzle head 7 which is shown to be conical, of the needle valve nozzle 2. The shut-off needle 3 is capable of sealing the material channel 5 toward the needle guide or toward the opening 4, it being possible, but not necessary, for the shut-off needle 3 to issue in this case—as shown in the present document—from the nozzle opening 4. During sealing of the channel 5, the tips of the shut-off needles 3 of the two coaxial needle valve nozzles 2 shown move apart from each other. The needle valve nozzles 2 shown are arranged on the hot runner manifold block 25, or secured therein, but project beyond the cooled mould plates 26 attached to the hot runner manifold block 25.

The drive system shown according to a first preferred embodiment of the invention has two coaxial pistons 16, 17, the common longitudinal axis L2 of which is arranged parallel and laterally offset from the longitudinal axis L1 of the needle valve nozzles 2. The two pistons 16, 17 shown each have a central axial hole 19, 22 in which a guide cylinder 18 is received. The guide cylinder 18 is coupled to the needle valve nozzles 2 or the shut-off needles 3 thereof via two lever arms 9 which protrude from at least one piston 13, 14 at an angle of substantially 90 degrees. The lever arm 9 or the fingers 9a, b thereof surround with at least one recess 10 both the neck of a spacer sleeve 6 and the needle head 8. The spacer sleeve 6 strikes in the needle valve a stop at the edge 40 of the hot runner block 25 and thus determines the distance by which the shut-off needle 3 extends.

The respective lever arm 9 is fastened to the piston 13, 14 for example, as shown in FIGS. 1a and 1b, by means of screws 39, although it may also be formed integrally in one piece. The guide cylinder 18 is fixed in a first fastening hole 19 in the first piston 13 (shown at the top in FIGS. 1a and 1b) using a fastening means 20, for example a fastening screw 20, whereas it is axially movable in a second hole 22, preferably running within a ball cage 21, in the second piston 14 (shown at the bottom in FIGS. 1a and 1b). The first or second piston 13, 14 has a first or second head region 16, 17, the head regions 16, 17 pointing away from each other in the drive assembly and each being protected from the surface of the mould plates 26 of the manifold unit 1 by a lid 37.

In the exemplary embodiment illustrated in FIGS. 1a and 1b, the two actuations, transmitted by the two lever arms 9, of the shut-off needles 3 are carried out synchronously, i.e. either both shut-off needles 3 are extended or both are retracted. For this purpose, the guide cylinder 18 is a guide element common to the two needle valve nozzles 2 shown. The movement of the piston or pistons 13, 14 causes the two lever arms 9 to part (see FIG. 1b) and thus to transmit a movement to the shut-off needles 3. Depending on the position of the piston 13, 14 in the cavity, there is arranged either a first piston chamber 23a or 24a between the head region 16, 17 and lid 37 or a second piston chamber 23b or 24b on the side of the flange 28 of the piston 13 or 14 facing the guide cylinder 18. A first piston chamber 23a, 24a is generally formed when the shut-off needle 3 is retracted, a second piston chamber 23b, 24b generally being formed when the shut-off needle 3 is extended. When the shut-off needle 3 is retracted, the second piston chamber 23b, 24b has a much smaller volume than the first piston chamber 23a, 24a, preferably a negligibly small volume. Conversely, when the shut-off needle 3 is extended, the first piston chamber 23a, 24a has a much smaller volume than the second piston chamber 23b, 24b, preferably a negligibly small volume. Medium is respectively applied to the piston chambers 23a, b, 24a, b by pneumatics or hydraulics for movement.

Each shut-off needle 3 has, at its end opposing the nozzle head 7 or at its base, a needle head 8 which is surrounded by a recess 10 in the lever arm 9 or one of the fingers 9a, b thereof. The longitudinal axis L1 extends centrally through the shut-off needle 3 substantially in the longitudinal direction. The axial movability of the shut-off needle 3 is backwardly limited by the finger 9a, b or the recess 10 therein for surrounding the needle head 8 and also by a protrusion 36 in the hot runner manifold block 25 in that the needle head 8 finds in the aforementioned elements a stop. The limitation of the needle movement forward (or in the direction of the nozzle head 7) is facilitated by the spacer sleeve 6 which defines the extended position of the shut-off needle 3. Spacer sleeves 6 of various sizes can be used in this case, thus allowing the extension or retraction path of the shut-off needle to be defined as desired. The spacer sleeve 6 is preferably configured substantially as a hollow cylinder with a peripheral incision with which the finger 9a, b of the lever arm 9 can engage. The single stroke 11a defined by the movement of the shut-off needle 3 is half the double stroke 11 arranged between two lever arms when the shut-off needles 3 of two coaxially arranged needle valve nozzles 2 are in the extended position. The leading rim of the spacer sleeve defines the front stop for the shut-off needle 3 at the edge 40 of the hot runner manifold block 25 and the rear stop is defined by the projection 36 in the hot runner manifold block 25. The lever arm 9, or the fingers 9a, b thereof, preferably engages both with the peripheral incision in the spacer sleeve 6 and also around the needle head 8 arranged at the trailing end of the spacer sleeve 6, the needle head 8 and the hollow cylinder portion, arranged at the back of the peripheral incision, of the spacer sleeve entering the recess 10 in the lever arm 9 or the fingers 9a, b thereof.

The plane E, which is arranged as a mirror plane in relation to the coaxially arranged needle valve nozzles 2 parallel to the surface of the hot runner manifold block 25 of the manifold unit 1, is a central centre plane perpendicular to the longitudinal axis L1.

FIG. 1a shows the two coaxial shut-off needles 3 in the retracted position, i.e. the channel 5 is open for the outflow of casting material. The lever arms 9 rest against one another substantially without a gap or without a double stroke 11 lying therebetween. The first piston 13 is located in the present illustration in a position where a first or second piston chamber 23a or 24a is formed between the head region 16, 17 and the lid 37. The U-shaped arrangement may be seen particularly clearly in FIGS. 1a and 1b, the illustrated finger 9a of the lever arm 9 shown at the top forming the crossbar of the upwardly open U for the needle valve nozzle 2 shown at the top in FIG. 1a, and the lower finger 9b of the lever arm 9 shown at the bottom forming the crossbar of the downwardly open U. The angles between the shut-off needle 3 and the finger 9a, b of the lever arm 9 and also between the finger 9a, b and the guide cylinder 18 are each substantially 90 degrees.

FIG. 1b shows, like FIG. 1a before it, a detail from a manifold unit 1 or supply device for a hot runner system, although in this case with extended shut-off needles 3. A double stroke 11 can in this case be seen between the two lever arms 9, as the two lever arms 9 are pressed apart and the lever arms 9 each press a shut-off needle 3 outwards, towards the opening 4 in the nozzle head 7. The opening 4 is sealed by the shut-off needle 3. In the view of FIG. 1b, the shut-off needle 3 issues from the nozzle head 7, although this does not necessarily have to be the case, to seal the casting material channel 5. The movement of the piston 18 in the cavity reduces the volume of the first piston chamber 23a, 24a in favour of the second piston chamber 23b, 24b or vice versa. The first piston chamber 23a, 24a is almost displaced in FIG. 1b, i.e. shown with a negligibly small volume. At the foot of the guide cylinder 18, a sealing bush 15 is shown in FIG. 1b closer to the lever arm 9 than in FIG. 1a. The two needle heads 8 no longer lie on the projection 36, as they have been pushed apart from each other by the two lever arms 9.

The first or second piston chamber 23a, 24a and the third or fourth piston chamber 23b, 24b are utilized hydraulically or pneumatically. In this case, a pneumatic system generates, for example, a pressure which can then be used to actuate the pistons 13, 14. This leads to a movement of the guide cylinder 18 in the axial direction along the longitudinal axis L2. The movement of the guide cylinder 18 is then transmitted to the lever arms 9 which control the shut-off needles 3 of the needle valve nozzles 2 via the needle head 8. The shut-off needle 3 can then be moved in the axial direction along the longitudinal axis L1, leading to extension or retraction of the shut-off needle 3. The stroke of the piston may correspond substantially to the stroke of the shut-off needle. The double stroke 11 between two lever arms is preferably, in the case of a coaxial arrangement of the needle valve nozzles 2 and a coaxial arrangement of the pistons 13, 14 driving the needle valve nozzles 2, substantially twice the single stroke 11a of the shut-off needle 3 or of a piston 13, 14.

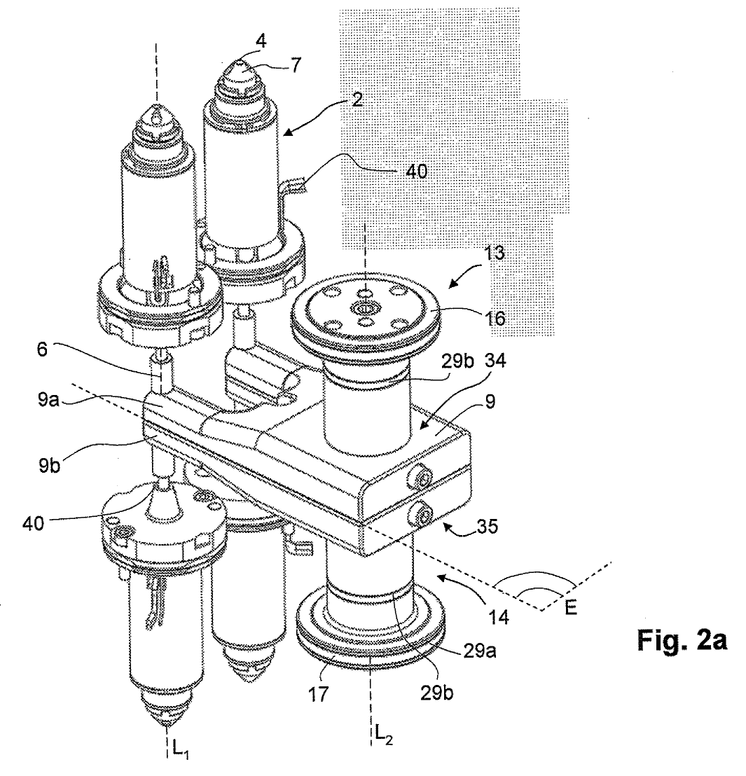

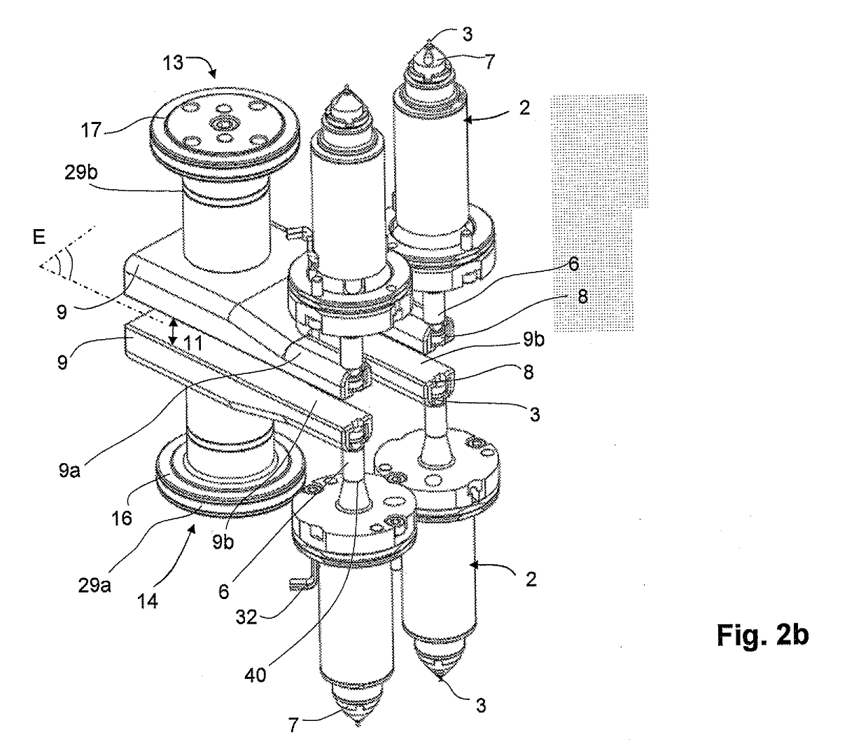

FIGS. 2a and 2b show four needle valve nozzles 2, the shut-off needles 3 of which can be jointly actuated by the two pistons 13, 14 shown via two lever arms 9. The two figures show that the needle valve nozzles 2 are coupled to the free ends of the fingers 9a, b. The needle valve nozzles 2 may be said to be arranged in pairs in the axial direction, i.e. along the longitudinal axis L1 of the needle valve nozzles 2 on a finger 9a, b, and two needle valve nozzles 2 may also be said to be arranged adjacently in pairs on a forked lever arm 9, wherein in the illustrated exemplary embodiment all four needle valve nozzles 2 can be operated simultaneously. Two seals 29a, b, which are for example rubber ring seals, surround the circumference of the head region 16, 17 and the neck of the piston 13, 14.

Whereas FIG. 2a shows four open needle valve nozzles 2, i.e. with shut-off needle 3 retracted and two adjacent lever arms 9, FIG. 2 shows four sealed needle valve nozzles 2, i.e. with shut-off needle 3 extended. In addition, FIG. 2b shows how in each case the free end of a finger 9a, b surrounds a needle head 8 of a shut-off needle 3 and the spacer sleeve 6. In accordance with the closed state of the needle valve nozzles 2, the two lever arms 9 shown are shown with a double stroke 11 lying between them.

Located in the hot runner manifold block 25 is a hot runner via which the liquid casting material, which is kept at temperature by the block heating line 31, is distributed to the various needle valve nozzles 2, which are heated by heating lines 32 in the jacket, via branches and manifolds. The casting material, which is heated by a block heating line 31, enters the hot runner manifold block 25 at a central manifold hole 12 and is led to the manifold in order then to be guided through inlet openings 38 into the individual needle valve nozzles 2 or material channels 5 thereof.

FIG. 3 is a perspective view of a preferred exemplary embodiment of the present invention, the hot runner manifold block 25 being shown with inserted needle valve nozzles 2 and drive systems. The illustrated exemplary embodiment comprises a manifold unit 1 with 32 needle valve nozzles 2, 16 of which are arranged on one side 34, the upper side shown in FIG. 3, of the manifold unit 1 and 16 of which are arranged on the opposing lower side 35 of the manifold unit 1. For each four needle valve nozzles 2, two drive systems are arranged, each with a piston 13, 14 and a lever arm 9. However, FIG. 3 does not show the entire manifold unit 1. The lower two pistons 13, 14 and lever arms 9 are missing from the right-hand front and back 8^{th} unit in the drawing. The back row of needle valve nozzles 2 has without exception extended shut-off needles 3, i.e. closed needle valve nozzles 2, whereas the front row of needle valve nozzles 2 has just two open nozzles 2, i.e. with retracted shut-off needles 3. In the rear left-hand 8^{th} unit, the double stroke 11 between the two lever arms 9 may be seen when the shut-off needle 3 is extended, the lever arms 9 of the left-hand pair of lever arms resting right up against each other in the front left-hand 8^{th} unit. The right-hand pair of lever arms have at the centre a small stroke, suggesting an intermediate stage, i.e. the needles 3 are at this location neither fully retracted nor fully extended.

### LIST OF REFERENCE NUMERALS

1 Manifold unit
2 Needle valve nozzle
3 Shut-off needle
4 Needle guide, opening
5 Material channel
6 Spacer sleeve
7 Nozzle head
8 Needle head
9 Lever arm
9a, b Finger
10 Recess in 9
11 Double stroke
11a Single stroke
12 Hot runner manifold hole
13 First piston
14 Second piston
15 Sealing bush
16 Head region of 13
17 Head region of 14
18 Guide cylinder
19 Fastening hole
Fastening screw
21 Ball cage
22 Second hole
23a First piston chamber for 16
23b Second piston chamber for 16
24a First piston chamber for 17
24b Second piston chamber for 17
25 Hot runner manifold block
26 Mould plates
27 Heating line connection
28 Flange of 13 or 14
29a, b Sealing elements
30 Cooling channel
31 Block heating line
32 Heating line for 2
33 Opening in 25
34 First side of 1
35 Second side of 1
36 Projection in the heating channel
37 Lid
38 Inlet opening in 2 for casting material
39 Fastening means
40 Edge of 25
L1 Longitudinal axis through 2
L2 Longitudinal axis through guide tube
E Centre plane through 2

1-15. (canceled)

16. A manifold unit for supplying casting material in an injection moulding system for processing thermoplastic materials via a hot runner system comprising at least one needle valve nozzle adapted to be sealed by a shut-off needle, wherein the shut-off needle can be moved by a hydraulic, electric, mechanical or pneumatic drive system, and wherein the needle valve nozzle has a first longitudinal axis, wherein the drive system, which has a piston, has a second longitudinal axis, and wherein the first longitudinal axis is arranged parallel to and laterally offset from the second longitudinal axis.

17. The manifold unit according to claim 16, wherein the shut-off needle is driven by the piston via a lever arm the shut-off needle is arranged substantially perpendicularly to the lever arm, and the longitudinal axis of the piston of the drive system is arranged substantially perpendicularly to the lever arm, so the shut-off needle, the lever arm and the piston describe a substantially U-shaped arrangement.

18. The manifold unit according to claim 16, wherein the lever arm is capable of surrounding with its free end at least one needle head, which is arranged at an end of the shut-off needle that is remote from a material outlet, and a spacer sleeve partly encasing the shut-off needle.

19. The manifold unit according to claim 16, wherein the manifold unit has at least two needle valve nozzles, the longitudinal axes of which are arranged coaxially, each needle valve nozzle having a nozzle head with an opening, which can be sealed by the shut-off needle, for the outflow of the casting material, the nozzle heads of the two needle valve nozzles pointing away from each other in opposite directions, and in that the shut-off needles of each two coaxially arranged needle valve nozzles can be moved by two coaxially arranged drive systems, the first drive system having a first piston and the second drive system having a second piston, and the drive systems having at least one common guide element.

20. The manifold unit according to claim 19, wherein the common guide element is a guide cylinder which is preferably arranged in a first axial fastening hole in the first piston and in a second axial hole in the second piston.

21. The manifold unit according to claim 20, wherein the first piston is screwed to the guide cylinder by means of a fastening screw which is guided in the first axial fastening hole in the first piston, and the guide cylinder being displaceably movable in the second axial hole in the second piston, the second axial hole preferably having a ball cage.

22. The manifold unit according to claim 19, wherein the first and the second piston are configured to actuate via two lever arms, which are arranged parallel to each other, at least two shut-off needles which are movably mounted in needle valve nozzles which are preferably arranged coaxially with one another and oriented in opposite directions.

23. The manifold unit according to claim 17, wherein the lever arm is capable of actuating at least one, preferably two or more shut-off needles which are mounted in needle valve nozzles which are arranged parallel to one another and oriented in the same direction.

24. The manifold unit according to claim 16, wherein the manifold unit has at least two needle valve nozzles, the longitudinal axes of which are arranged parallel to and laterally offset from one another, the nozzle heads of the two needle valve nozzles pointing in the same direction, and each needle valve nozzle having a nozzle head with an opening, which can be sealed by the shut-off needle, for the outflow of the casting material and in that the shut-off needles of the needle valve nozzles can be moved by a common drive system.

25. The manifold unit according to claim 17, wherein the lever arm is configured in a fork-like manner with at least two fingers, each finger preferably having at its free end a recess which is capable of surrounding the needle head and the spacer sleeve of the shut-off needle.

26. The manifold unit according to claim 16, wherein two coaxially arranged pistons together drive at least four shut-off needles, half of the four needle valve nozzles, in each of which a shut-off needle is received, being arranged on a first side of the manifold unit and the other half of the needle valve nozzles being arranged at a second side of the manifold unit opposing the first side.

27. The manifold unit according to claim 17, wherein each lever arm has an even number of fingers and in that preferably the lever arm is configured with at least two, preferably two or four, fingers, each finger being capable of actuating a shut-off needle.

28. The manifold unit according to claim 25, wherein the fingers are arranged on the lever arm around the piston in a circular or star-shaped manner.

29. The manifold unit according to claim 16, wherein a lever arm engages with at least one opening in a hot runner manifold block in which the at least one needle valve nozzle is arranged, the at least one drive system being arranged outside a hot runner manifold block.

30. The manifold unit according to claim 16, wherein the drive system is capable of operating a plurality of needle valve nozzles arranged parallel to and laterally offset from one another, the needle valve nozzles being coupled to the piston either via a common finger or via various fingers, which are arranged parallel to one another, of a lever arm.
